(19) United States
(12) Patent Application Publication
(10) Pub. No.: US 2011/0096019 A1
(43) Pub. Date: Apr. 28, 2011

(54) TOUCH PANEL AND TOUCH DISPLAY DEVICE

(75) Inventors: Ming-Yao Tsai, Hsinchu (TW); En-Hung Liu, Hsinchu (TW); Ching-Sheng Cheng, Hsinchu (TW); Chih-Hung Shih, Hsinchu (TW)

(73) Assignee: AU OPTRONICS CORP., Hsinchu (TW)

(21) Appl. No.: 12/756,299

(22) Filed: Apr. 8, 2010

(30) Foreign Application Priority Data
Oct. 22, 2009 (TW) 98135729

(51) Int. Cl. G06F 3/044; G06F 3/041

(52) U.S. Cl. 345/174; 345/173; 345/104

(57) ABSTRACT

A touch panel and a touch display device are provided. The touch panel includes a first substrate having an inner surface and an outer surface. A position sensing structure is disposed over the inner surface or the outer surface of the first substrate. A second substrate is disposed opposite to the first substrate, facing the inner surface of the first substrate. A plurality of press sensing structures is disposed between the first and the second substrates and a press signal connecting line is disposed to serially connect all of the press sensing structures. The touch display device includes the above mentioned touch panel.

### CROSS REFERENCE TO RELATED APPLICATIONS

This Application claims priority of Taiwan Patent Application No. 98135729, filed on Oct. 22, 2009, the entirety of which is incorporated by reference herein.

### BACKGROUND OF THE INVENTION

1. Field of the Invention

The present invention relates to a touch display device including a touch panel, and in particular relates to a touch panel having position sensing and press sensing structures.

2. Description of the Related Art

Conventional touch panels generally are capacitance sensing touch panels. The capacitance sensing touch panel is implemented by detecting the capacitance between a finger of a user and a sensing electrode of the capacitance sensing touch panel to determine the position of the finger. Referring to FIG. 1, a plane view of a sensing electrode structure of a conventional capacitance sensing touch panel is shown. The sensing electrode structure includes a plurality of X-axis sensing electrodes 10 and a plurality of Y-axis sensing electrodes 20. While a signal is scanning to one X-axis sensing electrode, the other X-axis sensing electrodes and Y-axis sensing electrodes are connected to a ground. Thus, a capacitance Cx-y is produced between the scanned X-axis sensing electrode and the other grounded Y-axis sensing electrodes. However, while the top of the scanned X-axis sensing electrode is touched by a finger, in addition to detecting the capacitance Cx-y, a capacitance Cx-f produced between the finger and the scanned X-axis sensing electrode is also detected. Accordingly, through a circuit analysis, the changes of capacitances occurring in the X-axis sensing electrodes are obtained. Using the same technique, while the Y-axis sensing electrodes are scanned, the changes of capacitances occurring in the Y-axis sensing electrodes are also obtained. Therefore, a two-dimension coordinate is obtained to determine the coordinate of the finger.

However, the capacitance sensing touch panels only determine the coordinates of the finger by the changes of capacitances, the capacitance sensing touch panels cannot sense the pressure on the touch panels. Accordingly, while the conventional touch panels implement an enter instruction into an input system software, the finger needs to press twice at the same position and an auxiliary software is needed to determine the action of the finger. If the positions of the finger pressing twice are shifted, or the time space between the two pressing actions is too long or too short, the instructions requested by the finger are not easily determined.

Therefore, a touch panel having a position sensing function and a press sensing function which work simultaneously to determine instructions from the finger, and prevent an aperture ratio of the touch panel from reducing is desired.

### BRIEF SUMMARY OF THE INVENTION

According to an illustrative embodiment, a touch panel is provided. The touch panel comprises: a first substrate having an inner surface and an outer surface. A position sensing structure which is disposed over the inner surface or the outer surface of the first substrate. A second substrate which is disposed opposite to the first substrate, facing the inner surface of the first substrate. A plurality of press sensing structures disposed between the first and the second substrates and a press signal connecting line which is disposed to series connect all of the press sensing structures.

According to an illustrative embodiment, a touch display device is provided. The touch display device comprises: a first substrate having an inner surface and an outer surface. A position sensing structure is disposed over the inner surface or the outer surface of the first substrate. A second substrate is disposed opposite to the first substrate, facing the inner surface of the first substrate. A plurality of press sensing structures is disposed between the first and the second substrates. A press signal connecting line is disposed to serially connect all of the press sensing structures and a display element is used for displaying images.

According to an illustrative embodiment, the touch display device further comprises an integrated circuit electrically connecting to the press signal connecting line and the display element, wherein the integrated circuit receives an instruction signal from the press signal connecting line to determine display images.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows an illustrative plane view of a sensing electrode of a conventional capacitance touch panel;

FIG. 2A shows an illustrative cross section of a touch panel according to an embodiment of the invention;

FIG. 2B shows an illustrative cross section of a touch panel according to another embodiment of the invention;

FIG. 2C shows an illustrative cross section of a touch panel according to another embodiment of the invention;

FIG. 3 shows an illustrative plane view of a portion of a touch panel according to an embodiment of the invention;

FIG. 4A shows an illustrative cross section of a touch panel along the cross section lines 1-1′, 2-2′, 3-3′ and 4-4′ of FIG. 3 according to an embodiment of the invention; and

FIG. 4B shows an illustrative cross section of a touch panel along the cross section lines 1-1′, 2-2′, 3-3′ and 4-4′ of FIG. 3 according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

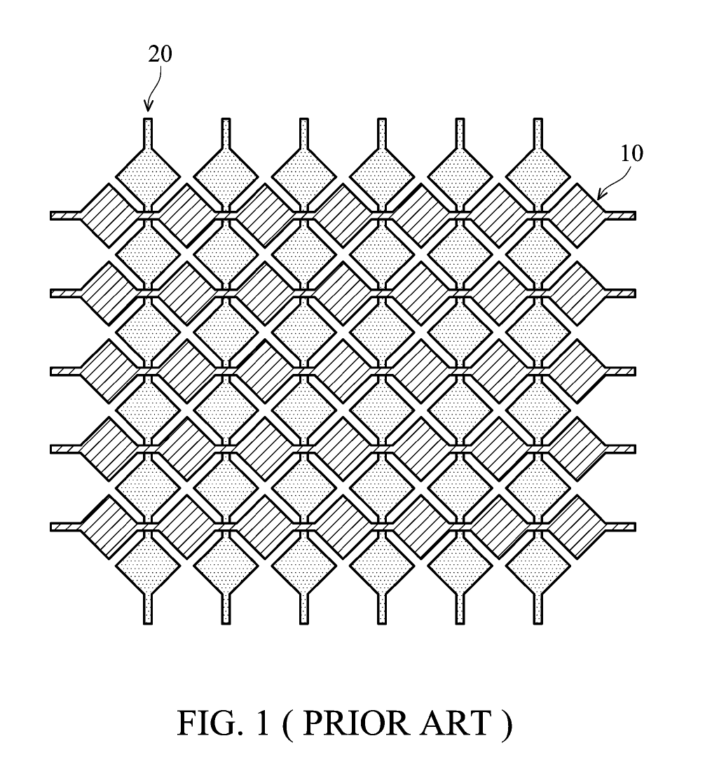

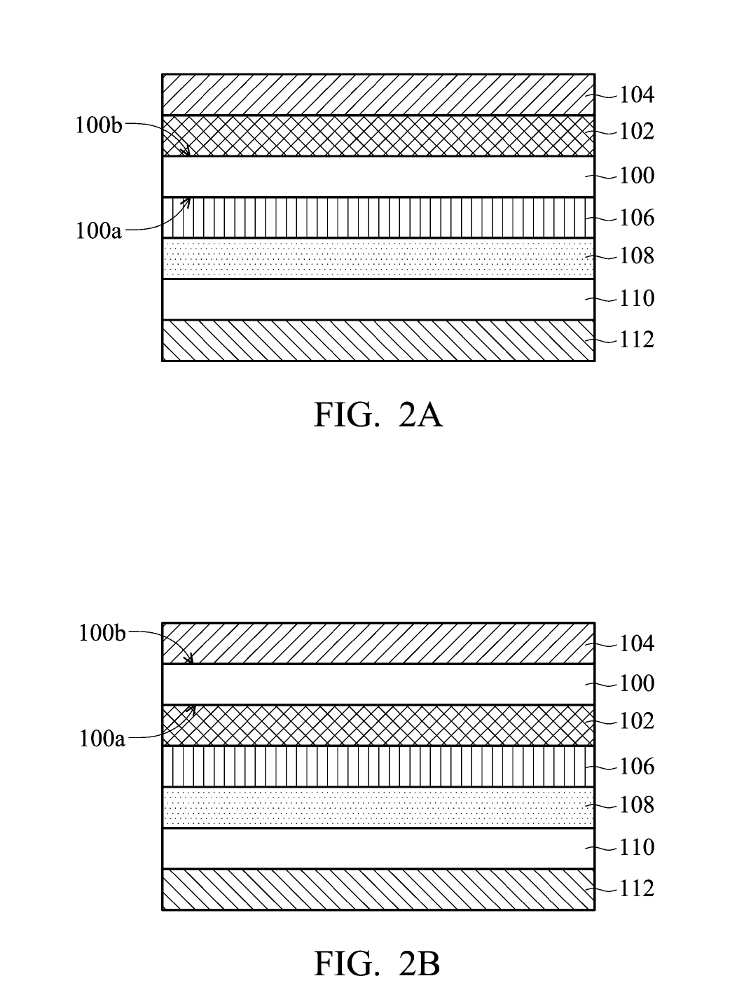

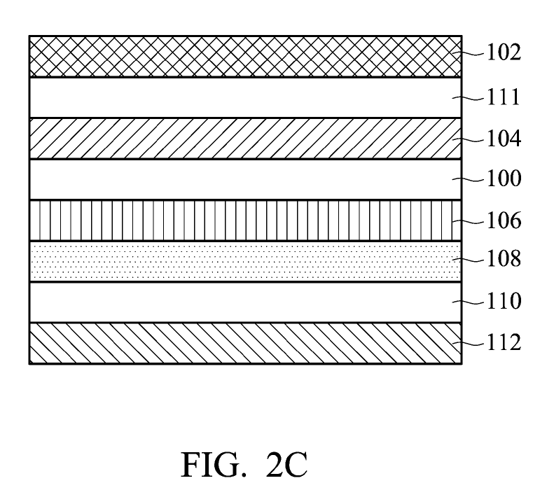

In an embodiment of the invention, a touch panel with a position sensing function and a press sensing function is simultaneously provided. Referring to FIG. 2A, a cross section of a touch panel according to an embodiment of the invention is shown. First, a first substrate 100 such as a glass substrate, having an inner surface 100a and an outer surface 100b is provided. A color filter layer 106 can be disposed on the inner surface 100a and a position sensing structure 102 may be disposed on the outer surface 100b. The position sensing structure 102 can detect the positions of the touch panel which are touched by a user. The position sensing structure 102 may be, for example, a capacitance sensing element as shown in FIG. 1, which can determine the touch positions by sensing a capacitance produced from a finger touching the touch panel. Moreover, in an embodiment, the position sensing structure 102 may be a photo sensing element (not shown), wherein two sets of a light emitter and a light receiver are disposed in an X-direction and a Y-direction, respectively. The photo sensing element can determine the touch positions by sensing the differences in brightness between the touched area and the areas not touched.

In addition, the touch panel further has a second substrate 110 disposed opposite to the first substrate 100, wherein the second substrate 110 faces the inner surface 100a of the first substrate 100. The second substrate 110 may be a glass substrate and has a plurality of thin film transistors (TFTs) and a plurality of electrodes (not shown) formed thereon. A plurality of press sensing structures 108 is disposed between the first substrate 100 and the second substrate 110, and arranged by an array type. The press sensing structures 108 sense electrical differences (voltage differences) produced from touching the touch panel to determine whether to implement the instruction displayed on the touch panel. In an embodiment, the touch panel may be a liquid crystal display panel, wherein a liquid crystal layer and the press sensing structures 108 are disposed in the same level structure. Moreover, the touch panel can further have a pair of an upper polarizer 104 and a lower polarizer 112 sandwiching the first substrate 100 and the second substrate 110, wherein the upper polarizer 104 is disposed adjacent to the first substrate 100 and the lower polarizer 112 is disposed adjacent to the second substrate 110.

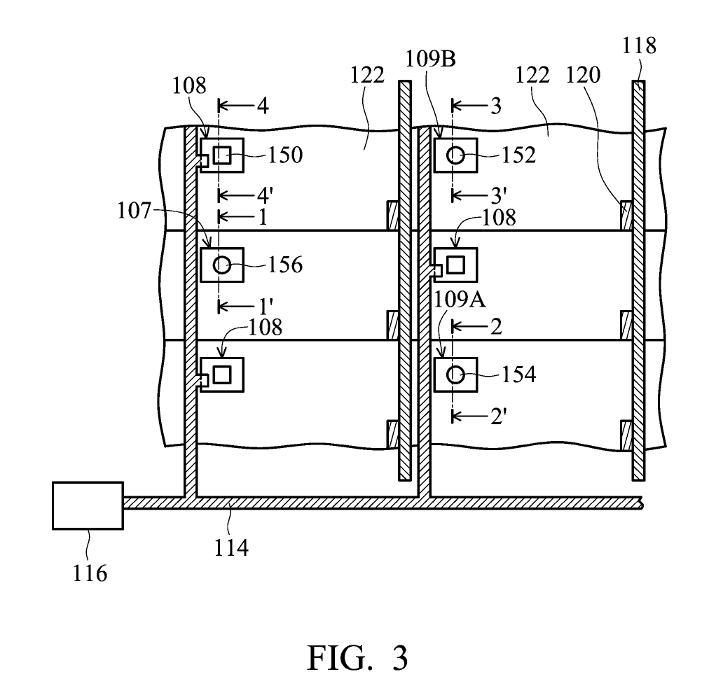

Next, referring to FIG. 2B, a cross section of a touch panel according to another embodiment of the invention is shown. The difference between the touch panels of FIG. 2B and FIG. 2A is that the position sensing structure 102 is disposed on the inner surface 100a of the first substrate 100 and the color filter layer 106 is disposed between the position sensing structure 102 and the press sensing structures 108 in FIG. 3B.

Referring to FIG. 2C, a cross section of a touch panel according to another embodiment of the invention is shown. The difference between the touch panels of FIG. 2C and FIG. 2A is that the position sensing structure 102 is disposed on a third substrate 111 and the third substrate 111 and the position sensing structure 102 are disposed above the upper polarizer 104 in FIG. 3C. The third substrate 111 may be a glass substrate or a flexible substrate.

Next, referring to FIG. 3, a plane view of a portion of a touch panel according to an embodiment of the invention is shown. The touch panel has a plurality of sub-pixels 122 and the sub-pixel 122 contains the press sensing structure 108 therein. The arrangement of the press sensing structures 108 in the sub-pixels 122 is not limited to the type of FIG. 3. In an embodiment, one press sensing structure 108 can be disposed in one sub-pixel 122 at an interval of one sub-pixel 122. In an embodiment, each sub-pixel 122 has one press sensing structure 108 disposed therein. In an embodiment, one press sensing structure 108 can be disposed in one sub-pixel 122 at an interval of more than one sub-pixel 122. In the embodiments, the press sensing structures 108 are arranged by an array type in the touch panel. In one embodiment of the touch panel of the invention, all the press sensing structures 108 are serially connected by a press signal connecting line 114 and further connected to an integrated circuit 116. The shape of the press signal connecting line 114 may be a comb shape, a reticulate shape or an irregular trend continuous line, which can series connect all of the press sensing structures 108.

In one embodiment of the touch panel of the invention, the second substrate 110 (as shown in FIG. 2A) further comprises a plurality of date lines 118 formed thereon, connecting to a plurality of control thin film transistors 120. In an embodiment, some portions of the press signal connecting line 114 can be disposed parallel to the date lines 118, and wherein the press signal connecting line 114 and the date lines 118 can be formed from the same conductive layer at the same time. In another embodiment, some portions of the press signal connecting line 114 can be disposed to overlap with the date lines 118, and wherein the press signal connecting line 114 is disposed over the date lines 118. Accordingly, an aperture ratio of the touch panel can be prevented from reducing. In this embodiment, the press signal connecting line 114 and the date lines 118 are formed from different layered conductive layers.

In the embodiments of the touch panel of the invention, because all of the press sensing structures 108 are series connected together by the press signal connecting line 114, when any position of the touch panel is pressed, the produced press sensing signal can be delivered to the integrated circuit 116 through the press signal connecting line 114 to determine whether to implement the instruction displayed on the touch panel. Moreover, in the embodiments of the invention, the position sensing structure 102 of the touch panel can determine touch position, such that there is no need to use additional sensor thin film transistors to connect with the less press sensing structures 108. Therefore, it can prevent an aperture ratio of the touch panel from reducing.

In addition, each sub-pixel 122 of the touch panel further has a major support structure 107 and auxiliary support structures 109A and 109B disposed therein. These support structures 107, 109A and 109B and the press sensing structures 108 may be disposed in different sub-pixels 122 respectively.

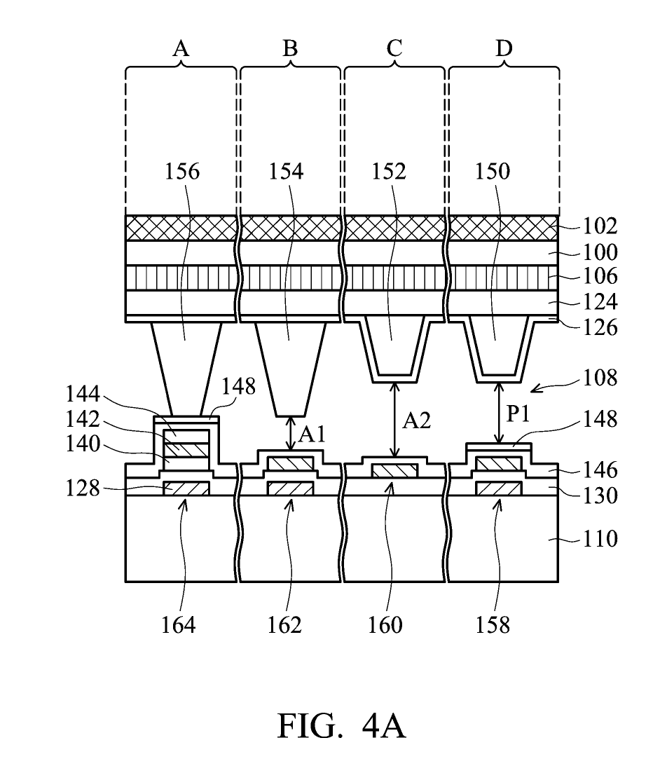

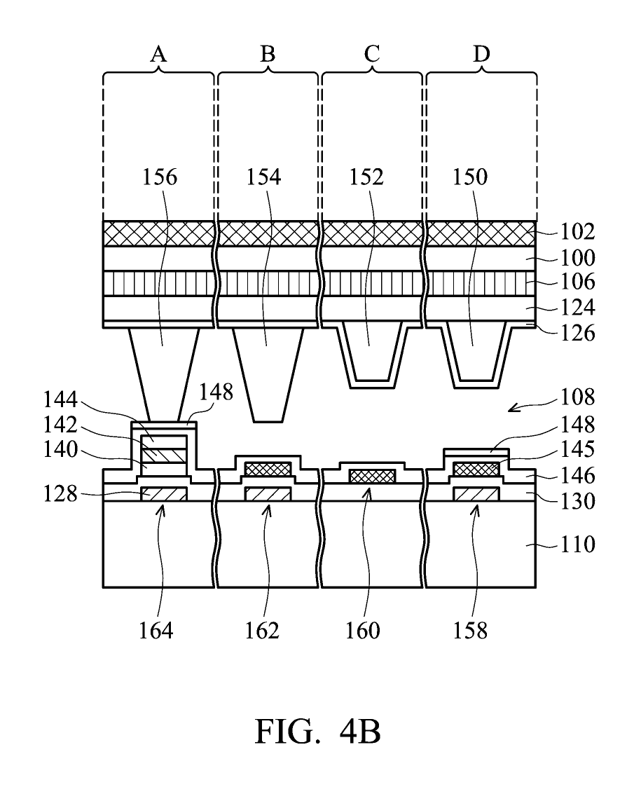

Next, referring to FIG. 4A, a cross section of a touch panel along the cross section lines 1-1′, 2-2′, 3-3′ and 4-4′ of FIG. 3 according to an embodiment of the invention is shown, corresponding to the areas A, B, C and D of FIG. 4A respectively. The press sensing structures 108 are arranged by array type. A cross section of each press sensing structure 108 is shown as the area D of FIG. 4A. A sensing spacer 150 is disposed over the first substrate 100. The first substrate 100 may further have the color filter layer 106 and an insulating layer 124 disposed thereon. The sensing spacer 150 may be disposed on the insulating layer 124 or on the color filter layer 106. In addition, the press sensing structure 108 further includes a sensing stage 158 disposed on the second substrate 110. The sensing stage 158 is usually formed from a first metal layer 128, a first dielectric layer 130, a second metal layer 142 and a second dielectric layer 146. In other embodiments, the sensing stage 158 can be formed from the other materials or the other arrangements of these materials.

Moreover, a first transparent conductive layer 126 and a second transparent conductive layer 148 are disposed on the sensing spacer 150 and the sensing stage 158, respectively. The first transparent conductive layer 126 and the second transparent conductive layer 148 may be formed from indium tin oxide (ITO). While the touch panel is not pressed, there is a sensing gap P1 between the first transparent conductive layer 126 on the sensing spacer 150 and the second transparent conductive layer 148 on the sensing stage 158. While the touch panel is pressed, the first transparent conductive layer 126 and the second transparent conductive layer 148 come in contact with each other to form a press sensing signal, such as a variation of an electric current or a voltage. Further, an instruction signal formed from the press sensing signal is delivered to the integrated circuit 116 through the press signal connecting line 114 for determining the requested display images by the integrated circuit 116.

In addition to the press sensing structures 108, in an embodiment of the invention, the touch panel further includes the major support structure 107 and the auxiliary support structures 109A and 109B. The heights of the spacers and the stages of the major support structure 107 and the auxiliary support structures 109A and 109B are different from the heights of the spacer and the stage of the press sensing structure 108. The major support structure 107 and the auxiliary support structures 109A and 109B are disposed in the same level structure with the press sensing structures 108 for providing a fixed space between the first substrate 100 and the second substrate 110. The major support structure 107 and the auxiliary support structures 109A and 109B can also be used as a buffer structure for the press sensing structures 108 to prevent the press sensing structures 108 from becoming damaged when the touch panel is pressed. A cross section of the major support structure 107 is shown as the area A of FIG. 4A. The major support structure 107 includes a first spacer 156 and a first stage 164 disposed opposite to the first spacer 156. The first spacer 156 and the first stage 164 are disposed on the first substrate 100 and the second substrate 110 respectively. When the touch panel is not pressed, the first spacer 156 and the first stage 164 are in contact with each other to provide a fixed space between the first substrate 100 and the second substrate 110. In an embodiment, the first stage 164 may be formed from the first metal layer 128, the first dielectric layer 130, a semiconductor layer 140, the second metal layer 142, a third dielectric layer 144 and the second dielectric layer 146. In addition, the second transparent conductive layer 148 can be disposed on the first stage 164, but the first transparent conductive layer 126 cannot be disposed on the first spacer 156. In another embodiment, the first spacer 156 and the sensing spacer 150 can be designed to have the same height, and thus the sensing gap P1 is formed from the difference of the heights between the first stage 164 and the sensing stage 158.

According to an embodiment of the invention, the touch panel further includes a second spacer 154 and a second stage 162 disposed in the same level structure with the press sensing structures 108, as the first auxiliary support structure 109A. A cross section of the first auxiliary support structure 109A is shown as the area B of FIG. 4A. When the touch panel is not pressed, there is a first auxiliary gap A1 between the second spacer 154 and the second stage 162. The first auxiliary gap A1 is smaller than the sensing gap P1. The first auxiliary support structure 109A can be used as a buffer structure for the press sensing structures 108 to prevent the press sensing structures 108 from becoming damaged when the touch panel is pressed. The second spacer 154 of the first auxiliary support structure 109A can have a height which is the same as the height of the first spacer 156, and the second stage 162 can have a height smaller than the height of the first stage 164. The second stage 162 is formed from the first metal layer 128, the first dielectric layer 130, the second metal layer 142 and the second dielectric layer 146. There is no transparent conductive layer formed on the second spacer 154 and the second stage 162.

According to another embodiment of the invention, the touch panel further includes a third spacer 152 and a third stage 160 disposed in the same level structure with the press sensing structures 108 to form the second auxiliary support structure 109B. A cross section of the second auxiliary support structure 109B is shown as the area C of FIG. 4A. While the touch panel is not pressed, there is a second auxiliary gap A2 between the third spacer 152 and the third stage 160. The second auxiliary gap A2 is greater than the sensing gap P1. The second auxiliary support structure 109B is also used as a buffer structure for the press sensing structures 108 to prevent the press sensing structures 108 from becoming damaged when the touch panel is pressed. The height of the third spacer 152 may be the same as the height of the sensing spacer 150, and the height of the third stage 160 may be smaller than the height of the sensing stage 158. The third stage 160 is formed from the first dielectric layer 130, the second metal layer 142 and the second dielectric layer 146. There may be no transparent conductive layer formed on the third stage 160.

The sensing spacer 150, the first spacer 156, the second spacer 154 and the third spacer 152 may be a photo spacer. In an embodiment of the invention, the sensing spacer 150, the sensing stage 158, the first spacer 156 and the first stage 164 are necessary for the touch panel. The other spacers and the other stages are not necessary and can be selectively disposed in the touch panel. In addition, the distribution density and the arrangement of the sensing spacer and the other spacers can be adjusted to satisfy the requirements for the touch panels.

Referring to FIG. 4B, a cross section of a touch panel along the cross section lines 1-1′, 2-2′, 3-3′ and 4-4′ of FIG. 3 according to another embodiment of the invention is shown, corresponding to the areas A, B, C and D of FIG. 4B respectively. The difference between FIG. 4B and FIG. 4A is that a third metal layer 145 is disposed between the first dielectric layer 130 and the second dielectric layer 146 in the sensing stage 158, the second stage 162 and the third stage 160. The press signal connecting line 114 (as shown in FIG. 3) is formed from the third metal layer 145, but the data lines 118 (as shown in FIG. 3) are formed from the second metal layer 142. Thus, the press signal connecting line 114 can overlap with the data lines 118 and be disposed over the data lines 118 to enhance the aperture ratio of the touch panel.

Further, in another embodiment of the invention, a touch display device including the above mentioned touch panel is provided. The touch display device includes a display element electrically connecting to the integrated circuit 116 for receiving the signal from the integrated circuit 116 to display images. The display element may be an electrophoretic display element, an organic light-emitting diode display element or a liquid crystal display element, which is usually disposed between the first substrate 100 and the second substrate 110 to form an electrophoretic display, an organic light-emitting diode display or a liquid crystal display. The integrated circuit 116 is electrically connected with the press signal connecting line 114 and the display element. The display element is well known by people skilled in the art, and not described in detail herein. The integrated circuit 116 receives the instruction signal from the press signal connecting line 114 to determine the subsequent request for the display images. The integrated circuit 116 can be independently disposed to receive the instruction signal from the press signal connecting line 114 or be integrated into a display control circuit to reduce the size of the control circuit of the touch display device.

In an embodiment of the invention, the plurality of press sensing structures are disposed between the first substrate and the second substrate and all of the press sensing structures are serially connected by the press signal connecting line. The press sensing structures are combined with the position sensing structure on the first substrate, such that the press instruction signals are directly detected to determine whether the user inputs an enter instruction. Accordingly, the instructions from the user are determined accurately by the touch panel, and the issues of error actions of the touch display device caused by error determining of the instructions are reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch panel, comprising:
a first substrate, having an inner surface and an outer surface;
a position sensing structure disposed over the inner surface or the outer surface of the first substrate;
a second substrate disposed opposite to the first substrate and facing the inner surface of the first substrate;
a plurality of press sensing structures arranged in an array and disposed between the first and the second substrates; and
a press signal connecting line disposed to series connect all of the press sensing structures to output an instruction signal.

2. The touch panel of claim 1, wherein the position sensing structure is disposed on the outer surface of the first substrate.

3. The touch panel of claim 1, further comprising a color filter layer disposed over the inner surface of the first substrate.

4. The touch panel of claim 3, wherein the position sensing structure is disposed on the inner surface of the first substrate, and disposed between the first substrate and the color filter layer.

5. The touch panel of claim 1, further comprising a pair of an upper polarizer and a lower polarizer sandwiching the first substrate and the second substrate, wherein the upper polarizer is disposed adjacent to the first substrate and the lower polarizer is

6. The touch panel of claim 5, further comprising a third substrate, wherein the position sensing structure is disposed on the third substrate, and the position sensing structure and the third substrate are disposed on the upper polarizer.

7. The touch panel of claim 1, wherein the press signal connecting line has a shape comprising a comb shape, a reticulate shape or an irregular trend continuous line.

8. The touch panel of claim 1, wherein the press signal connecting line is parallel to a data line.

9. The touch panel of claim 1, wherein the press signal connecting line overlaps with a data line and is disposed over the data line.

10. The touch panel of claim 1, wherein the press sensing structure comprises:
a sensing spacer;
a sensing stage disposed under the sensing spacer;
a first transparent conductive layer disposed on the sensing spacer and facing the sensing stage; and
a second transparent conductive layer disposed on the sensing stage, wherein the first transparent conductive layer and the second transparent conductive layer are separated by a sensing gap when the touch panel is not pressed.

11. The touch panel of claim 10, further comprising a first spacer disposed opposite to a first stage, wherein the first spacer and the first stage are disposed in the layer is not disposed on the first spacer, and the first spacer and the first stage contact each other while the touch panel is not pressed.

12. The touch panel of claim 11, further comprising a second spacer disposed opposite to a second stage, wherein the second spacer and the second stage are disposed in the same level structure with the press sensing structure, the first transparent conductive layer is not disposed on the second spacer, and the second spacer and the second stage are separated by a first auxiliary gap when the touch panel is not pressed, and wherein the first auxiliary gap is smaller than the sensing gap.

13. The touch panel of claim 12, wherein the second spacer has a height which is equal to the first spacer and the second stage has a height smaller than the height of the first stage.

14. The touch panel of claim 11, further comprising a third spacer disposed opposite to a third stage, wherein the third spacer and the third stage are disposed in the same level structure with the press sensing structure, the second transparent conductive layer is not disposed on the third stage, and the third spacer and the third stage are separated by a second auxiliary gap when the touch panel is not pressed, and wherein the second auxiliary gap is greater than the sensing gap.

15. The touch panel of claim 14, wherein the third spacer has a height the same as a height of the sensing spacer and the third stage has a height smaller than the height of the sensing stage.

16. The touch panel of claim 1, further comprising a liquid crystal layer disposed between the first substrate and the second substrate.

17. The touch panel of claim 1, wherein the press sensing structure is connected to the press signal connecting line directly without connecting with a sensing thin film transistor.

18. The touch panel of claim 1, wherein the position sensing structure determines a touch position.

19. The touch panel of claim 1, wherein the press sensing structures determine whether an instruction is implemented.

20. The touch panel of claim 1, wherein the position sensing structure comprises a capacitance sensing component or a photo sensing component.

21. A touch display device, comprising:
a first substrate, having an inner surface and an outer surface;
a position sensing structure disposed over the inner surface or the outer surface of the first substrate;
a second substrate disposed opposite to the first substrate and facing the inner surface of the first substrate;
a plurality of press sensing structures arranged in an array and disposed between the first and the second substrates;
a press signal connecting line disposed to series connect all of the press sensing structures to output an instruction signal; and
a display element disposed between the first and the second substrates to

22. The touch display device of claim 21, wherein the display element comprises an electrophoretic display element, an organic light-emitting diode display element or a liquid crystal display element.

23. The touch display device of claim 21, further comprising an integrated circuit electrically connecting to the press signal connecting line and the display element, wherein the integrated circuit receives the instruction signal from the press
